(19) United States
(12) Patent Application Publication
(10) Pub. No.: US 2025/0320893 A1
(43) Pub. Date: Oct. 16, 2025

(54) COAXIAL CONTRA-ROTATING CONNECTING MECHANISM

(71) Applicant: Hangzhou Amphenol Phoenix Telecom Parts Co., Ltd., Hangzhou, Zhejiang (CN)

(72) Inventor: Yuanyue ZHOU, Hangzhou, Zhejiang (CN)

(21) Appl. No.: 18/854,698

(22) PCT Filed: Mar. 20, 2023
(86) PCT No.: PCT/CN2023/082443

§ 371 Date: Oct. 7, 2024

(30) Foreign Application Priority Data
Apr. 7, 2022 (CN) 202220799960.9

(51) Int. Cl. F16C 11/10

(52) U.S. Cl. CPC F16C 11/10

(57) ABSTRACT

A coaxial contra-rotating connecting mechanism includes a left rotating connecting arm, a right rotating connecting arm, and a connecting shaft. The left rotating connecting arm and the right rotating connecting arm are respectively provided with a first connecting part and a second connecting part which are sleeved on the connecting shaft and are rotatably connected to the connecting shaft; a cam assembly which can slide rather than rotating relative to the connecting shaft is provided on the connecting shaft; the cam assembly is located between the first connecting part and the second connecting part; and the first connecting part and the second connecting part are respectively provided with structures matching the cam assembly, so that the left rotating connecting arm and the right rotating connecting arm synchronously rotate in opposite directions.

### FIELD OF THE INVENTION

The present invention relates to a synchronous contra-rotating mechanism, particularly relates to a hinge applied to portable mobile terminals such as notebook computers with flexible screens.

### BACKGROUND OF THE INVENTION

A foldable mobile terminal with flexible screen includes a left housing and a right housing which are connected by a hinge; and through the synchronous structure in the hinge, it achieves the synchronous contra-rotating. In the past, a synchronous structure mostly adopts a gear meshing structure, which has a tooth gap problem and require configuration of dual axes.

In addition, for a mobile terminal with flexible screen, in order to adapt to the shape of the flexible screen when it is folded, an avoidance rotation structure is provided for the hinge, which has a relatively complex structure and increases the quality risks and costs.

### SUMMARY OF THE INVENTION

It is an object of the present invention to provide a coaxial contra-rotating connecting mechanism, which can be applied to portable mobile terminals such as notebook computers with flexible screens to implement uniaxial contra-rotating connection, and thus can avoid the problem of a tooth gap in a gear engagement structure and the problem of the requirement for a biaxial configuration.

In order to achieve the above object, the present invention adopts the following technical solutions:

A coaxial contra-rotating connecting mechanism comprises a synchronous contra-rotating connecting mechanism and a fixing plate, wherein the synchronous contra-rotating connecting mechanism comprises a left rotating connecting arm, a right rotating connecting arm, and a connecting shaft; the connecting shaft is fixedly connected to the fixing plate, and the left rotating connecting arm and the right rotating connecting arm are respectively provided with a first connecting part and a second connecting part which are sleeved on the connecting shaft and are rotatably connected to the connecting shaft; a cam assembly which can slide rather than rotating relative to the connecting shaft is provided on the connecting shaft; the cam assembly is located between the first connecting part and the second connecting part; and the first connecting part and the second connecting part are respectively provided with structures matching the cam assembly, so that the left rotating connecting arm and the right rotating connecting arm synchronously rotate in opposite directions; the coaxial contra-rotating connecting mechanism is further provided with an elastic component and/or a threaded locking structure to compress the first connecting part, the cam assembly and the second connecting part, and the first connecting part and the second connecting part match the cam assembly at two ends of the am assembly so that the first connecting part and the second connecting part are positioned in the axial direction.

On the basis of adopting the above technical solutions, the present invention may also adopt the following further technical solutions, or use these further technical solutions in combination:

The cam assembly comprises a first cam and a second cam which are respectively an outer ring cam and an inner ring cam; the outer ring cam and the inner ring cam are sequentially sleeved on the connecting shaft, and are slidably connected rather than opposite rotating; two ends of the first cam and the two ends of the second cam are provided with cam control surfaces; in the rotating opening stroke of the left rotating connecting arm and the right rotating connecting arm, the first connecting part matches the first cam to drive the first cam to slide towards the second connecting part, and the second connecting part matches the first cam to drive the right rotating connecting arm to be rotatably opened by the first cam; the second connecting part matches the second cam to drive the second cam to slide towards the first connecting part, and the first connecting part matches the second cam to drive the left rotating connecting arm to be rotatably opened by the second cam; in the rotating closing stroke of the left rotating connecting arm and the right rotating connecting arm, the second connecting part matches the first cam to drive the first cam to slide towards the first connecting part, and the first connecting part matches the first cam to drive the left rotating connecting arm to be rotatably closed by the first cam; and the first connecting part matches the second cam to drive the second cam to slide towards the second connecting part, and the second connecting part matches the second cam to drive the right rotating connecting arm to be rotatably closed by the second cam.

The coaxial contra-rotating connecting mechanism comprises a left side four-bar mechanism and a right side four-bar mechanism, wherein, the four-bar mechanisms comprise first bars, second bars, third bars and fourth bars in sequence; the second bars in the four-bar mechanisms are fixed bars, and the third bars are provided with arc surfaces corresponding to a flexible screen bending arc; the coaxial contra-rotating connecting mechanism is provided with a left side connecting arm and a right side connecting arm which are provided with connecting parts for connecting to a mobile terminal with flexible screen; the left side connecting arm and the right side connecting arm are respectively combined with the fourth bars, the second bars are located on the fixing plate, and the connecting shaft is a rotary connecting shaft of the third bars and the second bars.

With a state corresponding to the mobile terminal with flexible screen during flattening as a reference state, a rotary axis of the third bars and the fourth bars in rotary connection is located above a flexible screen support surface when the mobile terminal with flexible screen is flattened, the left rotary connecting arm and the right rotary connecting arm are provided with first guide arc slide rails, and the circle center of the first guide arc slide rails is the rotary axis of the third bars and the fourth bars in rotary connection; the rotary axis of the first bars and the fourth bars in rotary connection is located above the flexible screen support surface when the mobile terminal with flexible screen is flattened, the left side connecting arm and the right side connecting arm are provided with second guide arc slide rails, and the circle center of the second guide arc slide rails is the rotary axis of the first bars and the fourth bars in rotary connection; by taking a thickness direction of the mobile terminal with flexible screen during flattening as a height direction, the position of the connecting shaft is lower than the position of the rotary connecting shaft of the first bars and the fixing plate in the height direction;

the left side connecting arm and the right side connecting arm are provided with first guide shafts correspondingly matching each first guide arc slide rail; and the first bars of the left side four-bar mechanism and the right side four-bar mechanism are provided with second guide shafts correspondingly matching the second guide arc slide rails.

The left side connecting arm and the right side connecting arm are provided with a pair of first guide shafts corresponding to each first guide arc slide rail; the first bars of the left side four-bar mechanism and the right side four-bar mechanism are provided with second guide shafts corresponding to each second guide arc slide rail; and the left side connecting arm and the right side connecting arm are provided with arc guide rails having the same radius as the second guide arc slide rails. Extending sections, outside the second guide shafts, of the first bars are provided with guide shafts matching the arc guide rails.

The left side connecting arm and the right side connecting arm contain a plurality of sheet metal parts; the left rotating connecting arm and the right rotating connecting arm also contain a plurality of sheet metal parts; the plurality of sheet metal parts of the left rotating connecting arm and the left side connecting arm are provided alternately; and the plurality of sheet metal parts of the right rotating connecting arm and the right side connecting arm are provided alternately to form a connecting mechanism with certain width.

The plurality of sheet metal parts of the left rotating connecting arm and the right rotating connecting arm are provided alternately on the connecting shaft and are in friction fit with one another to serve as a torsion mechanism for providing rotation resistance.

A front end and a rear end of the coaxial contra-rotating connecting mechanism are provided with the fixing plates; and one end of the connecting shaft is limited by a fixing plate while the other end thereof is provided with a thread and locked through a nut located outside the fixing plate at the other end.

The coaxial contra-rotating connecting mechanism provided by the present invention can achieve uniaxial contra-rotating connection, is high in synchronous stability (namely, no virtual position or shaking occurs during rotating), can be in press fit through the elastic component, and can always avoid gaps. Furthermore, according to the present invention, a simple folding structure simple can be applied, so it can adapt to the form of the flexible screen during bending under the condition that a lifting plate or a rotating plate is not used, and further arc support is provided for bent arc shape of the middle of the flexible screen; and it can be applied to hinge devices on digital products such as notebook computers, tablet personal computers and mobile phones. According to the present invention, cam transmission and friction surface are combined, thus the space is saved, the friction area is large, large torque can be provided, the rotating hand feeling is improved, or the function of stopping rotation at any time and positioning at any time is provided, and the force value can be kept unchanged in the whole process; and by means of the structure of the present invention, on the basis of guaranteeing supporting flatness, the use amount proportion of sheet metal parts can be increased, the structural strength is improved, and the cost is reduced.

### BRIEF DESCRIPTION OF THE DRAWINGS

FIG. 1 is a schematic diagram of an embodiment of the present invention when the corresponding mobile terminal is folded.

FIG. 2 is a schematic diagram of an embodiment of the present invention when the corresponding mobile terminal is flattened.

FIG. 3 is a three-dimensional schematic diagram of an embodiment of the present invention.

FIG. 4 is a schematic diagram of the bar connection in an embodiment of the present invention.

FIG. 5 is an exploded view of an embodiment of the present invention.

FIG. 6 is a top view of a synchronization structure in this embodiment when the corresponding mobile terminal is flattened.

FIG. 7 is a top view of a synchronization structure in this embodiment when the corresponding mobile terminal is folded, wherein the first cam is hidden.

FIG. 8 is a schematic diagram of a synchronization structure in this embodiment when the corresponding mobile terminal is folded.

### DETAILED DESCRIPTION

Referring to the figures, a coaxial contra-rotating connecting mechanism provided in the present invention comprises a synchronous contra-rotating connecting mechanism and a fixing plate 400, wherein the synchronous contra-rotating connecting mechanism comprises a left rotating connecting arm 100, a right rotating connecting arm 200, and a connecting shaft 300; the connecting shaft 300 is fixedly connected to the fixing plate 400, and the left rotating connecting arm 100 and the right rotating connecting arm 200 are respectively provided with a first connecting part 102 and a second connecting part 202 which are sleeved on the connecting shaft 300 and are rotatably connected to the connecting shaft 300; a cam assembly which can slide rather than rotating relative to the connecting shaft 300 is provided on the connecting shaft 300; the cam assembly is located between the first connecting part 102 and the second connecting part 202; and the first connecting part 102 and the second connecting part 202 are respectively provided with structures matching the cam assembly, so that the left rotating connecting arm 100 and the right rotating connecting arm 200 synchronously rotate in opposite directions.

The cam assembly comprises a first cam 500 and a second cam 900. In this embodiment, the first arm 500 is an outer ring cam, and the second cam 900 is an inner ring cam. The outer ring cam and the inner ring cam are sequentially sleeved on the connecting shaft 300, and the outer ring cam and the inner ring cam are slidably connected by sliding through the flat fit B rather than opposite rotating; two ends of the first cam 500 and the two ends of the second cam 900 are provided with cam control surfaces. The number of the structure of the first connecting part 102 matching the first cam 500 is 1021, and the number of the structure of the first connecting part 102 matching the second cam 900 is 1022; the number of the structure of the second connecting part 202 matching the first cam 500 is 2021, and the number of the structure of the second connecting part 202 matching the second cam 900 is 2022.

In the rotating opening stroke of the left rotating connecting arm 100 and the right rotating connecting arm 200 (i.e., during the process of rotating to open the applied mobile terminal), the structure 1021 of the first connecting part 102 matches the first cam 500 to drive the first cam 500 to slide towards the second connecting part 202, and the structure 2021 of the second connecting part 202 matches the first cam 500 to drive the right rotating connecting arm 200 to be rotatably opened by the first cam 500; the structure 2022 of the second connecting part 202 matches the second cam 900 to drive the second cam 900 to slide towards the first connecting part 102, and the structure 1022 of the first connecting part 102 matches the second cam 900 to drive the left rotating connecting arm 100 to be rotatably opened by the second cam 900;

in the rotating closing stroke of the left rotating connecting arm 100 and the right rotating connecting arm 200, the structure 2021 of the second connecting part 202 matches the first cam 500 to drive the first cam 500 to slide towards the first connecting part 102, and the structure 1021 of the first connecting part 102 matches the first cam 500 to drive the left rotating connecting arm 100 to be rotatably closed by the first cam 500; and the structure 1022 of the first connecting part 102 matches the second cam to drive the second cam 900 to slide towards the second connecting part 202, and the structure 2022 of the second connecting part 202 matches the second cam 900 to drive the right rotating connecting arm 200 to be rotatably closed by the second cam 900.

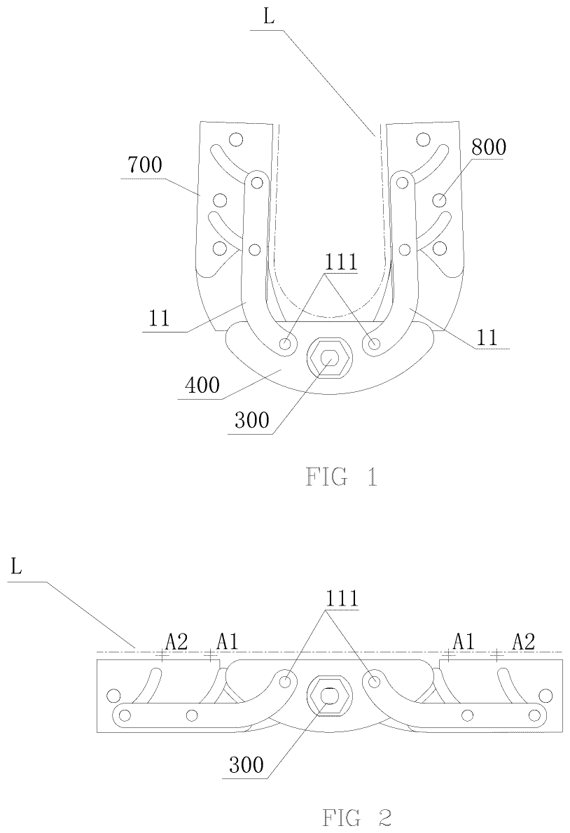

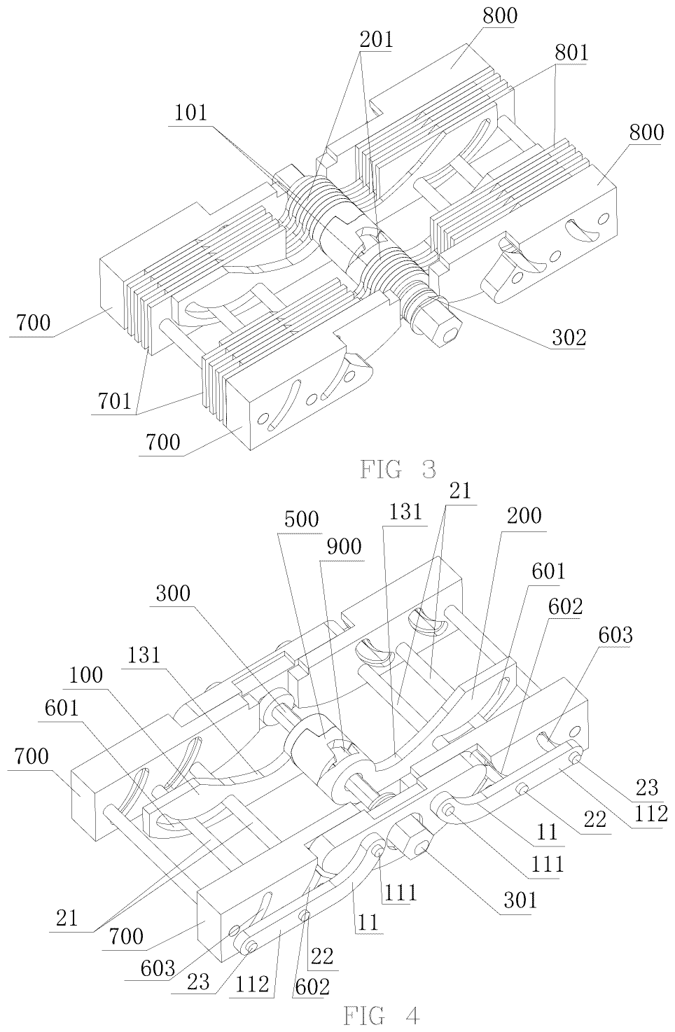

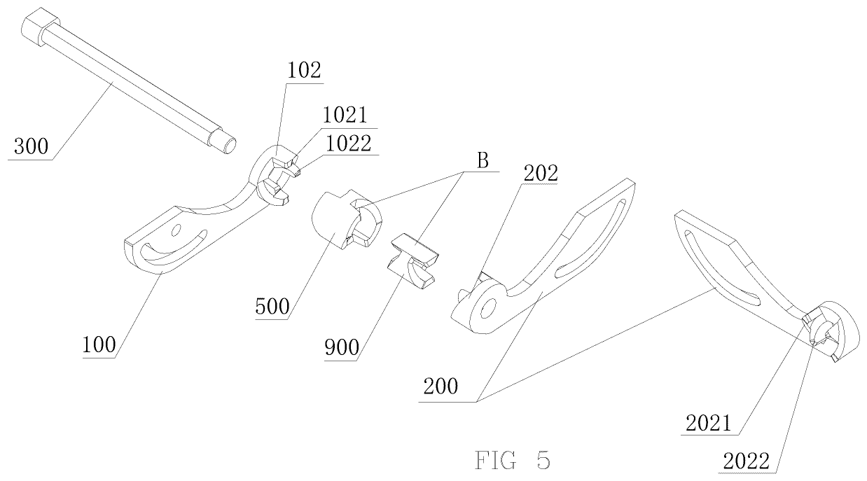

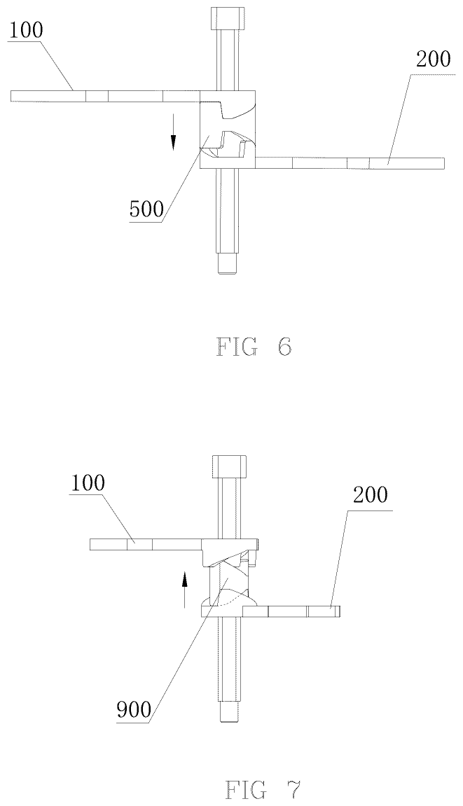

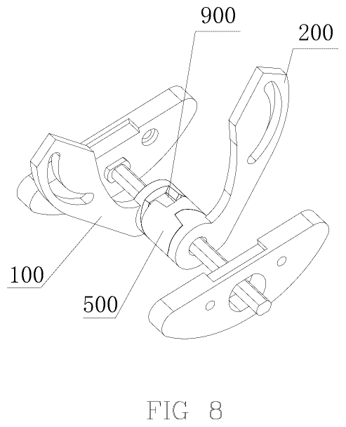

The coaxial contra-rotating connecting mechanism provided in the present invention comprises a left side four-bar mechanism and a right side four-bar mechanism, wherein, the four-bar mechanisms comprise first bars 11, second bars, third bars and fourth bars in sequence; the two ends of the first bar 11 are rotatably connected to the second bar and the fourth bar respectively, and the two ends of the third bar are rotatably connected to the second bar and the fourth bar, respectively. The second bars in the four-bar mechanisms are fixed bars, which are combined in the fixing plate 400, and the fixing plate 400 plays the role of the second bar. When in use, the four-bar mechanism is located below the flexible screen. In this embodiment, the third bars on the left and right sides are combined in the left rotating connecting arm 100 and the right rotating connecting arm 200, respectively. The third bar is provided with an arc surface 131 corresponding to a flexible screen bending arc; the arc surface 131 is preferably a circular arc surface. When the corresponding mobile terminal with flexible screen is in a folded state (FIG. 1), the circular arc surfaces of the left side four-bar mechanism and the right side four-bar mechanism rotate to be concentric or nearly concentric, so that the inner side length L of the mechanism remains unchanged during the opening and closing process at all angles. The coaxial contra-rotating connecting mechanism is provided with a left side connecting arm 700 and a right side connecting arm 800, and the left side connecting arm 700 and the right side connecting arm 800 are provided with connecting parts for connecting to the mobile terminal with flexible screen, for example, screw connecting holes; the left side connecting arm 700 and the right side connecting arm 800 are respectively combined with the fourth bars to play the role of the fourth bars.

By adjusting the length of the bars of the four-bar mechanism, the size of the internal space can be changed to meet the needs of product use. The four-bar mechanism of the present invention can also realize a virtual center rotation structure to make the design more flexible. With a state corresponding to the mobile terminal with flexible screen during flattening as a reference state (FIG. 2), a rotary axis A1 of the third bars and the fourth bars in rotary connection is located above a flexible screen support surface when the mobile terminal with flexible screen is flattened, the left rotary connecting arm 700 and the right rotary connecting arm 800 are provided with first guide arc slide rails 601 respectively, and the circle center of the first guide arc slide rails is the rotary axis A1 of the third bars and the fourth bars in rotary connection; the rotary axis A2 of the first bars 11 and the fourth bars in rotary connection is located above the flexible screen support surface when the mobile terminal with flexible screen is flattened, the left side connecting arm 700 and the right side connecting arm 800 are provided with second guide arc slide rails 602 respectively, and the circle center of the second guide arc slide rails is the rotary axis A2 of the first bars and the fourth bars in rotary connection. By taking a thickness direction of the mobile terminal with flexible screen during flattening as a height direction, the position of the connecting shaft 300 is lower than the position of the rotary connecting shaft 111 (real shaft) of the first bars 11 and the fixing plate 400 in the height direction, and the connecting shaft 300 is the rotary connecting shaft (real shaft) of the third bars and the second bars.

The left side connecting arm 700 and the right side connecting arm 800 are provided with a pair of first guide shafts 21 correspondingly matching each first guide arc slide rail 601, to realize the rotation connection between the fourth bars and the third bars. The first bars 11 of the left side four-bar mechanism and the right side four-bar mechanism are provided with second guide shafts 22 correspondingly matching the second guide arc slide rails 602. The left side connecting arm 700 and the right side connecting arm 800 are provided with arc guide rails 603 having the same radius as the second guide arc slide rails 602. Extending sections 112, outside the second guide shafts 22, of the first bars 11 are provided with guide shafts matching the arc guide rails 603.

Accordingly, in this embodiment, the portion of the fixing plate between the rotating shaft 300 and the connecting shaft 111 constitutes the second bar, the portion between the rotating shaft 300 and the rotary axis Al constitutes the third bar, and the portion between the rotary axis Al and the rotary axis A2 constitutes the fourth bar.

The left side connecting arm 700 and the right side connecting arm 800 contain a plurality of sheet metal parts 701, 801; the sheet metal parts 701, 801 are respectively penetrated by a pair of first guide shafts 21 and connected as a whole. The left rotating connecting arm 100 and the right rotating connecting arm 200 also contain a plurality of sheet metal parts 101, 201; The sheet metal parts 101, 201 are also respectively provided with the same first guide arc slide rails 601 and penetrated by a pair of first guide shafts 21, the plurality of sheet metal parts 101, 701 of the left rotating connecting arm 100 and the left side connecting arm 700 are provided alternately; and the plurality of sheet metal parts 201, 801 of the right rotating connecting arm 200 and the right side connecting arm 800 are provided alternately to form a connecting mechanism with certain width.

The plurality of sheet metal parts 101, 201 of the left rotating connecting arm 100 and the right rotating connecting arm 200 are provided alternately on the connecting shaft 300 and are in friction fit with one another to serve as a torsion mechanism for providing rotation resistance. The rotation resistance is used to provide the function of stopping the rotation and positioning the current angle at any time. The coaxial contra-rotating connecting mechanism can stop at any rotation angle (between 0° and 184° in this embodiment).

The coaxial contra-rotating connecting mechanism is also provided with an elastic component (a plurality of disc springs 302) and a threaded locking structure. A front end and a rear end of the coaxial contra-rotating connecting mechanism are provided with the fixing plates 400; and one end of the connecting shaft 300 is limited by a fixing plate 300 while the other end thereof is provided with a thread and locked through a nut 301 located outside the fixing plate 300 at the other end. The disc springs 302 are sleeved on both ends of the connecting shaft 300 to press the first connecting part 102, the cam assembly and the second connecting part 202. The first connecting part 102 and the second connecting part 202 are positioned axially by the matching of the first connecting part 102 and the second connecting part 202 with the cam assembly at both ends of the cam assembly.

The foregoing description only describes a specific embodiment of the present invention, but the structural features of the present invention are not limited thereto. Any changes or modifications made by those skilled in the art without departing from the spirit of the present invention shall fall within the scope of protection of the present invention.

It should be noted that the terms “comprise/include” and “has/have” and any variations thereof in the specification and claims of the present invention and the drawings are intended to cover non-exclusive inclusions. The terms “mounted”, “set”, “provided with”, “connected to/with”, “interconnected to/with”, “sleeved” should be understood in a broad sense. For example, it can be “fixedly connected”, “detachably connected”, or “integrally constructed”; or “mechanically connected” or “electrically connected”; or “directly connected”, or “indirectly connected through an intermediary”, or it can be “internally connected” between two devices, elements, or components. For those of ordinary skill in the art, the specific meanings of these terms in the present invention can be understood according to the specific circumstances.

It should be appreciated that, in the description of the present invention, the terms indicating the orientation or position relationship such as “one end”, “the other end”, “outside”, “inside”, “horizontal”, “end part”, “length”, “outer end”, “left”, “right”, “up/upward”, “down/downward”, etc., are based on the orientation or position relationship shown in the drawings, and are only for the convenience of describing the present invention and simplifying the description, rather than indicating or implying that the device or element referred to must have a specific orientation, be constructed and operated in a specific orientation, and therefore these terms cannot be understood as a limitation on the present invention.

1. A coaxial contra-rotating connecting mechanism, comprising a synchronous contra-rotating connecting mechanism and a fixing plate, wherein the synchronous contra-rotating connecting mechanism comprises a left rotating connecting arm, a right rotating connecting arm, and a connecting shaft, the connecting shaft is fixedly connected to the fixing plate, and the left rotating connecting arm and the right rotating connecting arm are respectively provided with a first connecting part and a second connecting part which are sleeved on the connecting shaft and are rotatably connected to the connecting shaft; a cam assembly which can slide rather than rotating relative to the connecting shaft is provided on the connecting shaft, the cam assembly is located between the first connecting part and the second connecting part, and the first connecting part and the second connecting part are respectively provided with structures matching the cam assembly, so that the left rotating connecting arm and the right rotating connecting arm synchronously rotate in opposite directions;
the coaxial contra-rotating connecting mechanism is further provided with an elastic component and/or a threaded locking structure to compress the first connecting part, the cam assembly and the second connecting part, and the first connecting part and the second connecting part match the cam assembly at two ends of the am assembly so that the first connecting part and the second connecting part are positioned in the axial direction.

2. The coaxial contra-rotating connecting mechanism according to claim 1, wherein the cam assembly comprises a first cam and a second cam which are respectively an outer ring cam and an inner ring cam, the outer ring cam and the inner ring cam are sequentially sleeved on the connecting shaft, and are slidably connected rather than opposite rotating; two ends of the first cam and the two ends of the second cam are provided with cam control surfaces;
in the rotating opening stroke of the left rotating connecting arm and the right rotating connecting arm, the first connecting part matches the first cam to drive the first cam to slide towards the second connecting part, and the second connecting part matches the first cam to drive the right rotating connecting arm to be rotatably opened by the first cam; the second connecting part matches the second cam to drive the second cam to slide towards the first connecting part, and the first connecting part matches the second cam to drive the left rotating connecting arm to be rotatably opened by the second cam;
in the rotating closing stroke of the left rotating connecting arm and the right rotating connecting arm, the second connecting part matches the first cam to drive the first cam to slide towards the first connecting part, and the first connecting part matches the first cam to drive the left rotating connecting arm to be rotatably closed by the first cam; the first connecting part matches the second cam to drive the second cam to slide towards the second connecting part, and the second connecting part matches the second cam to drive the right rotating connecting arm to be rotatably closed by the second cam.

3. The coaxial contra-rotating connecting mechanism according to claim 1, wherein the coaxial contra-rotating connecting mechanism comprises a left side four-bar mechanism and a right side four-bar mechanism, wherein, the four-bar mechanisms comprise first bars, second bars, third bars and fourth bars in sequence; the second bars in the four-bar mechanisms are fixed bars, and the third bars are provided with arc surfaces corresponding to a flexible screen bending arc, the coaxial contra-rotating connecting mechanism is provided with a left side connecting arm and a right side connecting arm which are provided with connecting parts for connecting to a mobile terminal with flexible screen; the left side connecting arm and the right side connecting arm are respectively combined with the fourth bars, the second bars are located on the fixing plate, and the connecting shaft is a rotary connecting shaft of the third bars and the second bars.

4. The coaxial contra-rotating connecting mechanism according to claim 3, wherein with a state corresponding to the mobile terminal with flexible screen during flattening as a reference state, a rotary axis of the third bars and the fourth bars in rotary connection is located above a flexible screen support surface when the mobile terminal with flexible screen is flattened, the left rotary connecting arm and the right rotary connecting arm are provided with first guide arc slide rails, and the circle center of the first guide arc slide rails is the rotary axis of the third bars and the fourth bars in rotary connection; the rotary axis of the first bars and the fourth bars in rotary connection is located above the flexible screen support surface when the mobile terminal with flexible screen is flattened, the left side connecting arm and the right side connecting arm are provided with second guide arc slide rails, and the circle center of the second guide arc slide rails is the rotary axis of the first bars and the fourth bars in rotary connection; by taking a thickness direction of the mobile terminal with flexible screen during flattening as a height direction, the position of the connecting shaft is lower than the position of the rotary connecting shaft of the first bars and the fixing plate in the height direction;
the left side connecting arm and the right side connecting arm are provided with first guide shafts correspondingly matching each first guide arc slide rail; and the first bars of the left side four-bar mechanism and the right side four-bar mechanism are provided with second guide shafts correspondingly matching the second guide arc slide rails.

5. The coaxial contra-rotating connecting mechanism according to claim 3, wherein the left side connecting arm and the right side connecting arm are provided with a pair of first guide shafts corresponding to each first guide arc slide rail; the first bars of the left side four-bar mechanism and the right side four-bar mechanism are provided with second guide shafts corresponding to each second guide arc slide rail; the left side connecting arm and the right side connecting arm are provided with arc guide rails having the same radius as the second guide arc slide rails, extending sections, outside the second guide shafts, of the first bars are provided with guide shafts matching the arc guide rails.

6. The coaxial contra-rotating connecting mechanism according to claim 3, wherein the left side connecting arm and the right side connecting arm contain a plurality of sheet metal parts; the left rotating connecting arm and the right rotating connecting arm also contain a plurality of sheet metal parts, the plurality of sheet metal parts of the left rotating connecting arm and the left side connecting arm are provided alternately, and the plurality of sheet metal parts of the right rotating connecting arm and the right side connecting arm are provided alternately to form a connecting mechanism with certain width.

7. The coaxial contra-rotating connecting mechanism according to claim 6, wherein the plurality of sheet metal parts of the left rotating connecting arm and the right rotating connecting arm are provided alternately on the connecting shaft and are in friction fit with one another to serve as a torsion mechanism for providing rotation resistance.

8. The coaxial contra-rotating connecting mechanism according to claim 1, wherein a front end and a rear end of the coaxial contra-rotating connecting mechanism are provided with the fixing plates, and one end of the connecting shaft is limited by a fixing plate while the other end thereof is provided with a thread and locked through a nut located outside the fixing plate at the other end.
